(19) United States
(12) Patent Application Publication
(10) Pub. No.: US 2018/0217631 A1
(43) Pub. Date: Aug. 2, 2018

(54) Mountable Display for Different Surfaces

(71) Applicant: Marsiste Adolphe, Freehold, NJ (US)

(72) Inventor: Marsiste Adolphe, Freehold, NJ (US)

(21) Appl. No.: 15/886,824

(22) Filed: Feb. 1, 2018

Related U.S. Application Data
(60) Provisional application No. 62/453,047, filed on Feb. 1, 2017.

(51) Int. Cl. G06F 1/16; F16M 13/02

(52) U.S. Cl. CPC G06F 1/1601; F16M 13/02; G09F 9/301; G06F 1/1635; G06F 1/1639

(57) ABSTRACT

A mountable display for different surfaces is an apparatus that is used to display audiovisual content onto a wall or a window. The apparatus can also be used to act as a privacy cover for a wall or window. The apparatus includes at least one transparent flexible panel, a micro-processor, a micro-projector, an audio output device, a wireless communication module, and a surface-attachment mechanism. The surface-attachment mechanism attaches the transparent flexible panel to a wall or a window. The micro-processor manages audiovisual content, which is outputted through the micro-projector and the audio output device. The micro-projector projects the visual portion of the audiovisual content onto the transparent flexible panel. The wireless communication module exchanges data between the micro-processor and an external computing device. The transparent flexible panel is also configured with tint in order to act as a privacy cover. At least one power source provides power to the apparatus.

The current application claims a priority to the U.S. Provisional Patent application Ser. No. 62/453,047 filed on Feb. 1, 2017.

### FIELD OF THE INVENTION

The present invention generally relates to a mountable display that can be attached onto different surfaces, such as a window or a wall. More specifically, the present invention can be used to output audiovisual content or act as a privacy cover.

### BACKGROUND OF THE INVENTION

Many vehicular accidents, fatal and non-fatal, are caused due to glare of the sun. Even though many different drivers chose to wear sunglasses to overcome this problem, sunglasses cannot fully absorb the sun glare as it leaks into the driver's eyesight around the frame of the sunglasses.

It is an objective of the present invention to provide a solution to the aforementioned problem as the present invention overcomes the sun glare while a vehicle is driven and enhances other user-friendly functionalities when the vehicle is stationary. More specifically, the present invention provides a tint for the windshield of the vehicle to block out the sun glare so that the vehicles can be safely driven. The tine feature also functions as an additional privacy barrier by blocking out the interior view of the vehicle as the intensity of the tint can be adjusted through the present invention. Additionally, the present invention functions as a mobile advertisement platform, a security device, and a live streaming platform. For example, the mobile advertisement platform can display personal preferences such as team logos, flags, nondiscriminatory personal messages and feelings, holiday greetings, political slogans, stickers, license plates, nature themes, religious messages, and other similar digital messages. The present invention is not limited vehicles and can be utilized within houses, boats, doors, and other related environments.

### BRIEF DESCRIPTION OF THE DRAWINGS

FIG. 1 is a schematic side view of the present invention with one transparent flexible panel.

FIG. 2 is a schematic side view of the present invention with two transparent flexible panel.

FIG. 3 is a detailed schematic side view of the transparent flexible panel for the present invention.

FIG. 4 is a block diagram illustrating the electronic connections between components of the present invention.

FIG. 5 is a block diagram illustrating the electrical connections between components of the present invention.

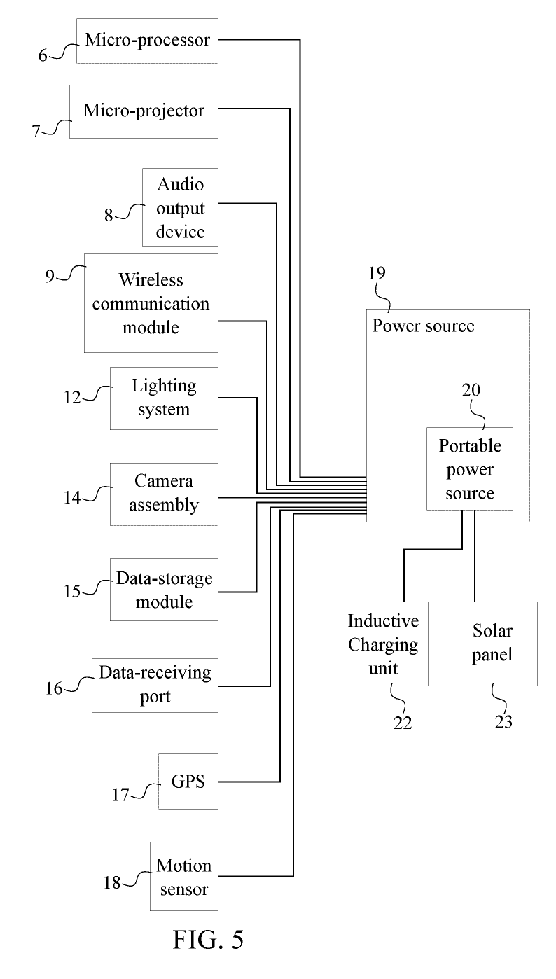

### DETAILED DESCRIPTION OF THE INVENTION

All illustrations of the drawings are for the purpose of describing selected versions of the present invention and are not intended to limit the scope of the present invention.

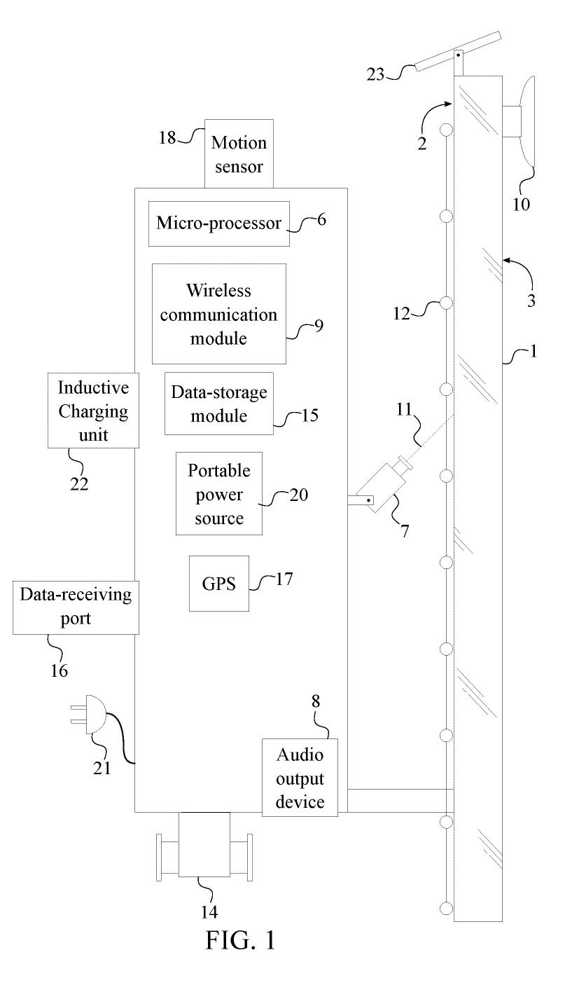

The present invention is a mountable display for different surfaces and can be used either to display audiovisual content or to act as a privacy cover. The present invention is typically applied to a wall or a window, which are typically blank surfaces with no aesthetic appeal. For example, the present invention can be applied to a wall in order to display audiovisual content (e.g. advertisements) to people passing by the wall. Also for example, the present invention can be applied to a window in order to reduce the window's transparency. As can be seen in FIG. 1, the preferred embodiment of the present invention comprises at least one transparent flexible panel 1, a micro-processor 6, a micro-projector 7, a wireless communication module 9, a surface-attachment mechanism 10, and a power source 19. The micro-projector 7 is a miniaturized image projector that is used to output the visual portion of any audiovisual content. The transparent flexible panel 1 is attached across the blank surface of a wall or a window and is used as a projector screen for the micro-projector 7. The transparent flexible panel 1 may be configured with a constant opacity or an adjustable opacity, which allows the transparent flexible panel 1 to act as a privacy cover. The transparent flexible panel 7 is also able to conform to a curved surface of a wall or window (e.g. a curved windshield of a car). The audio output device 8 is typically a speaker that is used to output the audio portion of any audiovisual content. The wireless communication module 9 is used to wirelessly communicate data to and from the present invention. The wireless communication module 9 can be used to communicate over local area network (i.e. WiFi), personal area network (e.g. Bluetooth), or both. The micro-processor 6 is used to manage and control the different functionalities for the electronic components of the present invention. The surface-attachment mechanism 10 allows the transparent flexible panel 1 to attach the blank surface of a wall or window. The surface-attachment mechanism 10 can be, but is not limited to, a set of suction cups or an adhesive. The power source 19 is used to power the electronic components of the present invention.

The general configuration for the aforementioned components allows the present invention to efficiently and effectively display audiovisual content on or act as a privacy cover for either a wall or a window. The transparent flexible panel 1 comprises a proximal face 2 and a distal face 3, which are opposite faces of the transparent flexible panel 1. The micro-processor 6, the micro-projector 7, the audio output device 8, and the wireless communication module 9 are mounted adjacent to the proximal face 2, while the surface-attachment mechanism 10 is mounted adjacent to the distal face 3. This arrangement prevents the micro-processor 6, the micro-projector 7, the audio output device 8, and the wireless communication module 9 from interfering as the present invention is attached across a blank surface by the surface-attachment mechanism 10. In addition, mounting to the proximal face 2 for components of the present invention can be done by an enclosure, a scaffolding, a frame, or any other kind of structural support. Moreover, an emission axis 11 of the micro-projector 7 is oriented towards the transparent flexible panel 1 so that the micro-projector 7 is able to project the visual portion of any audiovisual content upon and across the transparent flexible panel 1. The micro-processor 6 is electronically connected to the micro-projector 7, the audio output device 8, and the wireless communication module 9 so that the micro-processor 6 can receive any audiovisual content through the wireless communication module 9, process the audiovisual content into a visual portion and an audio portion, then send the visual portion to the micro-projector 7, and simultaneously send the audio portion to the audio output device 8. Finally, the power source 19 is electrically connected to the micro-processor 6, the micro-projector 7, the audio output device 8, and the wireless communication module 9 in order to readily power these electronic components as the audiovisual content is being processed and outputted by the present invention.

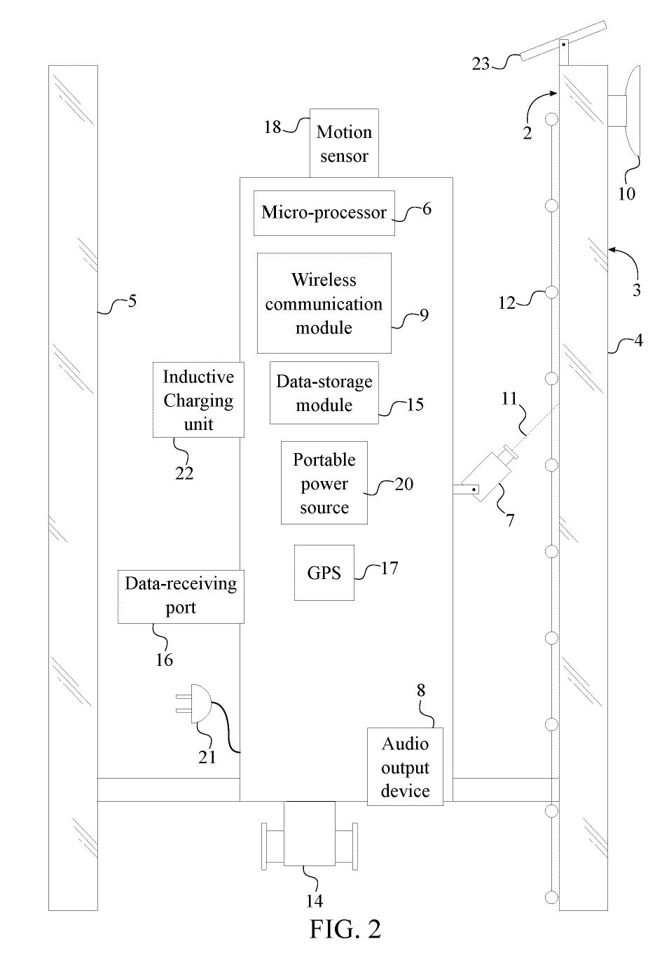

In one embodiment of the present invention shown in FIG. 2, the at least one transparent flexible panel 1 comprises a first panel 4 and a second panel 5, which are used to house the electronic components of the present invention. A lateral perimeter of the first panel 4 and a lateral perimeter of the second panel 5 are coextensive to each other so that the first panel 4 and the second panel 5 are able to display audiovisual content or act as a privacy cover for the same sized surface area of a wall or a window. In order to create the necessary housing space for the electronic components of the present invention, the first panel 4 and the second panel 5 need to mounted parallel and offset to each other. Consequently, the micro-processor 6, the micro-projector 7, and the wireless communication module 9 are mounted in between the first panel 4 and the second panel 5 or within the created housing space of the present invention.

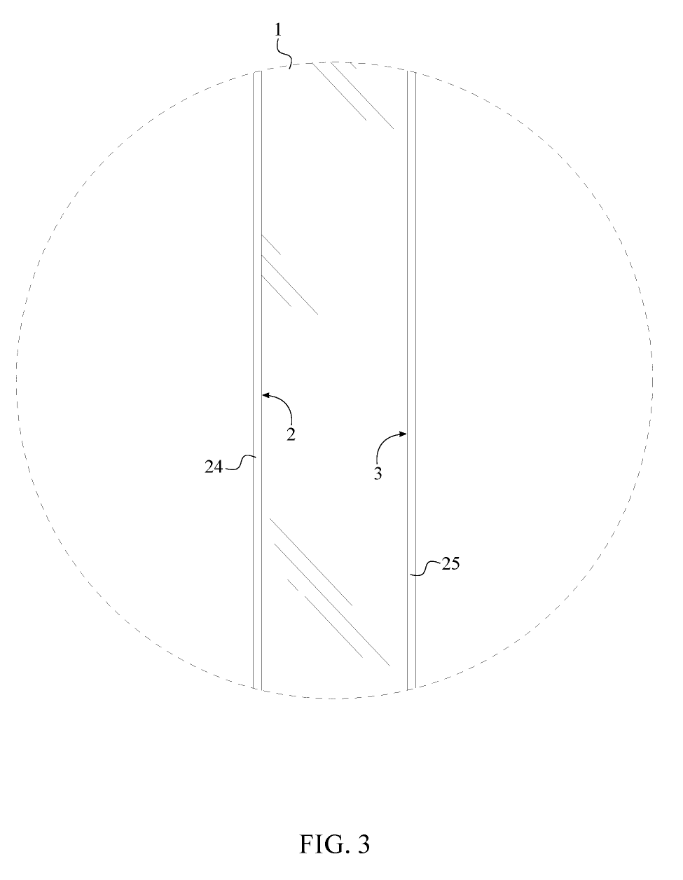

Moreover, the transparent flexible panel 1 may be configured with some additional features in order to improve the functionality of the transparent flexible panel 1. One such feature is the reversibility of the transparent flexible panel 1 so that the transparent flexible panel 1 can be attached in either direction across a blank surface. Another such feature is that the transparent flexible panel 1 is optically configured with a tint, which allows the present invention to act as a privacy cover if the present invention is attached to a window. The tint prevents people passing by the present invention to completely see through the transparent flexible panel 1 and prevents direct sunlight from traversing through the transparent flexible panel 1. In reference to FIG. 3, another such feature is a first weatherproofing film 24 and a second weatherproof film 25, which are used to protect the transparent flexible film 1 from physically damaging environmental conditions, such as rain and snow. Thus, the first weatherproofing film 24 is superimposed across the proximal face 2, and the second weatherproofing film 25 is superimposed across the distal face 3 so that the first weatherproofing film 24 and the second weatherproofing film 25 are able to protect the transparent flexible panel 1 from both sides. In reference to FIGS. 1, 2, 3, and 4, another such feature is a lighting system 12, which is used to provide back-lighting for the transparent flexible panel 1. The lighting system 12 is mounted across the transparent flexible panel 1 in order to enhance the luminosity across an entire image being projected onto the transparent flexible panel 1 by the micro-projector 7. The lighting system 12 is electronically connected to the micro-processor 6 so that the micro-processor 6 is able to readily activate the lighting system 12 in conjunction with the micro-projector 7. The micro-processor 6 is able to manage the amount of luminosity generated by the lighting system 12. The lighting system 12 is also electrically connected to the power source 19 so that the power source 19 is able to readily power the lighting system 12.

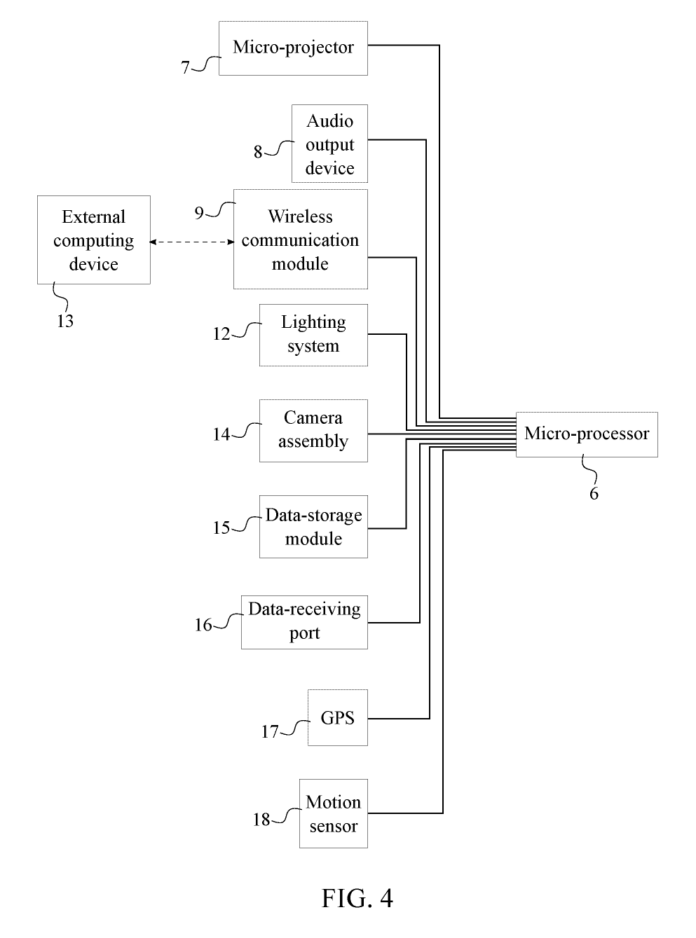

As can be seen in FIG. 4, the present invention may further comprise an external computing device 13, which allows the present invention to retrieve, store, and process data at a remote location from the transparent flexible panel 1. Thus, the external computing device 13 needs to be communicably coupled to the wireless communication module 9. For example, the micro-processor 6 could send search parameters based on the current location of the transparent flexible panel 1 to the external computing device 13. The external computing device 13 could then execute a search through its database to find advertisements that are geared towards a certain demographic within the current location of the transparent flexible panel 1. The external computing device 13 would then send those advertisements back to the micro-processor 6. Moreover, the external computing device 13 can be, but is not limited to, a remote server, a desktop, a laptop, a tablet personal computer (PC), or a smartphone. As mentioned above, the wireless communication module 9 can communicate with the external computing device 13 over a local area network, a personal area network, or any other kind of wireless communication method.

As can be seen in FIGS. 1, 2, 3, and 4, the present invention may further comprise a camera assembly 14, which is used by the present invention to capture its own audiovisual content from the surroundings of the present invention. Thus, the camera assembly 14 needs to be electronically connected to the micro-processor 6 so that the micro-processor 6 is able to retrieve and process any piece of audiovisual content. For example, the camera assembly 14 can capture a video of a person walking by the transparent flexible panel 1. The micro-processor 6 can then retrieve the video and graphically integrated into an advertisement that is displayed to the person walking by the transparent flexible panel 1. Similar to the other electronic components, the camera assembly 14 is mounted adjacent to the proximal face 2. The camera assembly 14 is also electrically connected to the power source 19 so that the power source 19 is able to readily power the camera assembly 14.

As can be seen in FIGS. 1, 2, 3, and 4, the present invention may further comprise a data-storage module 15, which allows the present invention to retrieve, store, and process data through a hardwire connection to the micro-processor 6. Thus, the data-storage module 15 needs to be electronically connected to the micro-processor 6. For example, the micro-processor 6 could readily search through and retrieve preset advertisements from the data-storage module 15. Similar to the other electronic components, the data-storage module 15 is mounted adjacent to the proximal face 2. The data-storage module 15 is also electrically connected to the power source 19 so that the power source 19 is able to readily power the data-storage module 15. The data-storage module 15 can be, but is not limited to, a mechanical hard drive or a solid-state drive.

As can be seen in FIGS. 1, 2, 3, and 4, the present invention may further comprise a data-receiving port 16, which allows the present invention to retrieve and process data from a physically-removable data-storage device, such as a secure digital (SD) card, an external hard drive, a memory stick, or a universal serial bus (USB) flash drive. Thus, the data-receiving port 16 needs to be electronically connected to the micro-processor 6 so that, once the physically-removable data-storage device is plugged into the data-receiving port 16, the micro-processor 6 is able to directly access the data on the physically-removable data-storage device. The removable data-storage device could contain any specific piece of audiovisual content that a user wants to personally upload onto the present invention. Similar to the other electronic components, the data-receiving port 16 is mounted adjacent to the proximal face 2. The data-receiving port 16 is also electrically connected to the power source 19 so that the power source 19 is able to readily power the data-receiving port 16.

As can be seen in FIGS. 1, 2, 3, and 4, the present invention may further comprise a global positioning (GPS) module 17, which allows the present invention to identify and process its geospatial location. The GPS module 17 needs to be electronically connected to the micro-processor 6 so that the micro-processor 6 can process data with reference to its geospatial location. For example, if the micro-processor 6 can identify certain current events that are related to its geospatial location, then the micro-processor 6 can retrieve audiovisual data related to those current events. Also for example, if the micro-processor 6 can identify certain demographics that are related to its geospatial location, then the micro-processor 6 can retrieve audiovisual data related to those demographics. Similar to the other electronic components, the GPS module 17 is mounted adjacent to the proximal face 2. The GPS module 17 is also electrically connected to the power source 19 so that the power source 19 is able to readily power the GPS module 17.

As can be seen in FIGS. 1, 2, 3, and 4, the present invention may further comprise a motion sensor 18, which allows the present invention to identify a person walking by the transparent flexible panel 1. The motion sensor 18 needs to be electronically connected to the micro-processor 6 so that, once the motion sensor 18 detects a person nearby the transparent flexible panel 1, the micro-processor 6 activates the micro-projector 7 and/or the audio output device 8 in order to display a piece of audiovisual content to the nearby person. The motion sensor 18 allows the present invention to only activate when a person is nearby and consequently allows the present invention to be energy efficient. Similar to the other electronic components, the motion sensor 18 is mounted adjacent to the proximal face 2. The motion sensor 18 is also electrically connected to the power source 19 so that the power source 19 is able to readily power the motion sensor 18.

As can be seen in FIGS. 1, 2, and 4, the at least one power source 19 may comprise a portable power source 20 (e.g. a battery), a power cable 21 (e.g. an alternative current [AC] power cord), or both. The portable power source 20 is able to temporarily power the electronic components of the present invention in remote locations, where an electrical outlet may not be available for the present invention. In addition, the present invention may further comprise an inductive charging unit 22 as a way to wirelessly recharge the portable power source 20. Thus, the inductive charging unit 22 needs to be electrically connected to the portable power source 20. Similar to the other electronic components, the inductive charging unit 22 is mounted adjacent to the proximal face 2. Furthermore, the present invention may further comprise at least one solar panel 23 as a way to naturally recharge the portable power source 20. Thus, the solar panel 23 is electrically connected to the portable power source 20. The solar panel 23 is also mounted peripheral to the proximal face 2 so that the other components of the present invention do not block the solar panel 23 from collecting sunlight. Finally, the power cable 21 is able to permanently power the electronic components of the present invention when the present invention is in the vicinity of an electrical outlet. If necessary, the power cable 21 is also able to recharge the portable power source 20. The power cable 21 is tethered adjacent to the proximal face 2 so that the power cable 21 can be easily accessed and plugged into an electrical outlet.

Some miscellaneous aspects of the present invention improve the overall functionality of the present invention. One such aspect is that all data and or ads will be housed and mirrored at specified servers, cloud computing, and other technology to secure data. Another such aspect is that all of the electronic components of the present invention are electronically connected through a motherboard and other standard low technologies. Another such aspect is that the follow features can be optionally integrated into the present invention: using an array of light emitting diodes (LEDs) with multicolor options and themes; a durable absorbent light shield material; a motherboard with hardware and software; chips and processors; circuitry board and configurations; applications for mobile device control; software control via phone; lithium batteries and solar/light energy; alternative current or direct current (AC/DC) power; a light material adjustable bar; a security sensor; a tracking sensor; a thief deterrent; an infrared technology plus; a night and day adjustment; an alpha-numerical display; a graphic; a two dimensional display; a set of live pictures and others; a set of cartoon and others; a three dimensional and higher display and others; a capability to upload/download data; a speaker; a microphone; memory cards; SD cards; a hard drive; a hard memory; random access memory (RAM); a small processor; a graphic board and display; a liquid crystal display (LCD); an LED display; and an advertisement platform.

Although the invention has been explained in relation to its preferred embodiment, it is to be understood that many other possible modifications and variations can be made without departing from the spirit and scope of the invention as hereinafter claimed.

What is claimed is:

1. A mountable display for different surfaces comprises:
at least one transparent flexible panel;
a micro-processor;
a micro-projector;
an audio output device;
a wireless communication module;
a surface-attachment mechanism;
an at least one power source;
the transparent flexible panel comprises a proximal face and a distal face;
the micro-processor, the micro-projector, the audio output device, and the wireless communication module being mounted adjacent to the proximal face;
the surface-attachment mechanism being mounted adjacent to the distal face;
an emission axis of the micro-projector being oriented towards the transparent flexible panel;
the micro-processor being electronically connected to the micro-projector, the audio output device, and the wireless communication module; and
the power source being electrically connected to the micro-processor, the micro-projector, the audio output device, and the wireless communication module.

2. The mountable display for different surfaces as claimed in claim 1 comprises:
the at least one transparent flexible panel comprises a first panel and a second panel;
a lateral perimeter of the first panel and a lateral perimeter of the second panel being coextensive to each other;
the first panel and the second panel being mounted parallel and offset to each other; and
the micro-processor, the micro-projector, and the wireless communication module being mounted in between the first panel and the second panel.

3. The mountable display for different surfaces as claimed in claim 1, wherein the transparent flexible panel is optically configured with a tint.

4. The mountable display for different surfaces as claimed in claim 1 comprises:
a first weatherproofing film;
a second weatherproofing film;
the first weatherproofing film being superimposed across the proximal face; and
the second weatherproofing film being superimposed across the distal face.

5. The mountable display for different surfaces as claimed in claim 1 comprises:
a lighting system;
the lighting system being mounted across the transparent flexible panel;
the lighting system being electronically connected to the micro-processor; and
the lighting system being electrically connected to the power source.

6. The mountable display for different surfaces as claimed in claim 1 comprises:
an external computing device; and
the external computing device being communicably coupled to the wireless communication module.

7. The mountable display for different surfaces as claimed in claim 1 comprises:
a camera assembly;
the camera assembly being mounted adjacent to the proximal face;
the camera assembly being electronically connected to the micro-processor; and
the camera assembly being electrically connected to the power source.

8. The mountable display for different surfaces as claimed in claim 1 comprises:
a data-storage module;
the data-storage module being mounted adjacent to the proximal face;
the data-storage module being electronically connected to the micro-processor; and
the data-storage module being electrically connected to the power source.

9. The mountable display for different surfaces as claimed in claim 1 comprises:
a data-receiving port;
the data-receiving port being mounted adjacent to the proximal face;
the data-receiving port being electronically connected to the micro-processor; and
the data-receiving port being electrically connected to the power source.

10. The mountable display for different surfaces as claimed in claim 1 comprises:
a global positioning system (GPS) module;
the GPS module being mounted adjacent to the proximal face;
the GPS module being electronically connected to the micro-processor; and
the GPS module being electrically connected to the power source.

11. The mountable display for different surfaces as claimed in claim 1 comprises:
a motion sensor;
the motion sensor being mounted adjacent to the proximal face;
the motion sensor being electronically connected to the micro-processor; and
the motion sensor being electrically connected to the power source.

12. The mountable display for different surfaces as claimed in claim 1 comprises:
the at least one power source comprises a portable power source; and
the portable power source being mounted adjacent to the proximal face.

13. The mountable display for different surfaces as claimed in claim 12 comprises:
an inductive charging unit;
the inductive charging unit being mounted adjacent to the proximal face; and
the inductive charging unit being electrically connected to the portable power source.

14. The mountable display for different surfaces as claimed in claim 12 comprises:
at least one solar panel;
the solar panel being mounted peripheral to the proximal face; and
the solar panel being electrically connected to the portable power source.

15. The mountable display for different surfaces as claimed in claim 1 comprises:
the at least one power source comprises a power cable; and
the power cable being tethered adjacent to the proximal face.

16. A mountable display for different surfaces comprises:
at least one transparent flexible panel;
a micro-processor;
a micro-projector;
an audio output device;
a wireless communication module;
a surface-attachment mechanism;
an at least one power source;
an external computing device;
a global positioning system (GPS) module;
a motion sensor;
the transparent flexible panel comprises a proximal face and a distal face;
the micro-processor, the micro-projector, the audio output device, and the wireless communication module being mounted adjacent to the proximal face;
the surface-attachment mechanism being mounted adjacent to the distal face;
an emission axis of the micro-projector being oriented towards the transparent flexible panel;
the micro-processor being electronically connected to the micro-projector, the audio output device, and the wireless communication module;
the power source being electrically connected to the micro-processor, the micro-projector, the audio output device, and the wireless communication module;
the transparent flexible panel being optically configured with a tint;
the external computing device being communicably coupled to the wireless communication module;
the GPS module being mounted adjacent to the proximal face;
the GPS module being electronically connected to the micro-processor;
the GPS module being electrically connected to the power source;
the motion sensor being mounted adjacent to the proximal face;
the motion sensor being electronically connected to the micro-processor; and
the motion sensor being electrically connected to the power source.

17. The mountable display for different surfaces as claimed in claim 16 comprises:
the at least one transparent flexible panel comprises a first panel and a second panel;
a lateral perimeter of the first panel and a lateral perimeter of the second panel being coextensive to each other;
the first panel and the second panel being mounted parallel and offset to each other; and
the micro-processor, the micro-projector, and the wireless communication module being mounted in between the first panel and the second panel.

18. The mountable display for different surfaces as claimed in claim 16 comprises:
a first weatherproofing film;
a second weatherproofing film;
a lighting system;
the first weatherproofing film being superimposed across the proximal face;
the second weatherproofing film being superimposed across the distal face;
the lighting system being mounted across the transparent flexible panel;
the lighting system being electronically connected to the micro-processor; and
the lighting system being electrically connected to the power source.

19. The mountable display for different surfaces as claimed in claim 16 comprises:
a camera assembly;
a data-storage module;
a data-receiving port;
the camera assembly being mounted adjacent to the proximal face;
the camera assembly being electronically connected to the micro-processor;
the camera assembly being electrically connected to the power source;
the data-storage module being mounted adjacent to the proximal face;
the data-storage module being electronically connected to the micro-processor;
the data-storage module being electrically connected to the power source;
the data-receiving port being mounted adjacent to the proximal face;
the data-receiving port being electronically connected to the micro-processor; and
the data-receiving port being electrically connected to the power source.

20. The mountable display for different surfaces as claimed in claim 16 comprises:
an inductive charging unit;
at least one solar panel;
the at least one power source comprises a portable power source and a power cable;
the power cable being tethered adjacent to the proximal face;
the portable power source being mounted adjacent to the proximal face;
the inductive charging unit being mounted adjacent to the proximal face;
the inductive charging unit being electrically connected to the portable power source;
the solar panel being mounted peripheral to the proximal face; and
the solar panel being electrically connected to the portable power source.
